(19) United States
(12) Patent Application Publication
(10) Pub. No.: US 2024/0280470 A1
(43) Pub. Date: Aug. 22, 2024

(54) METHOD TO PERFORM A MECHANICAL ADHESION TEST FOR THIN FILM INTERFACES

(71) Applicant: ams OSRAM International GmbH, Regensburg (DE)

(72) Inventors: Moses Richter, Regensburg (DE); Andreas Rueckerl, Konzell (DE)

(21) Appl. No.: 18/570,525

(22) PCT Filed: Jun. 18, 2021
(86) PCT No.: PCT/EP2021/066701

§ 371 Date: Dec. 14, 2023

(51) Int. Cl. G01N 19/04; G01N 3/20

(52) U.S. Cl. CPC G01N 19/04; G01N 3/20; G01N 2203/0091

(57) ABSTRACT

In an embodiment a method includes providing a substrate with a plurality of optoelectronic components and at least one test component arranged on a support element on the substrate, wherein the at least one test component is adjacent to at least one of the plurality of the optoelectronic components, wherein the support element comprises a plurality of first support pillars each connected to the substrate and an interface layer arranged between the optoelectronic components and the at least one test component, respectively, and the first support pillars, the interface layer forming a top surface of the first support pillars, and wherein the at least one test component is arranged on the top surface of an associated first support pillar such that the at least one test component protrudes a projection of the top surface at least in a first direction, applying a force to the at least one test component, and determining the force applied to the at least test component and/or a deflection of the at least one test component over time.

### CROSS-REFERENCE TO RELATED APPLICATIONS

This patent application is a national phase filing under section 371 of PCT/EP2021/066701, filed Jun. 18, 2021, which is incorporated herein by reference in its entirety.

### TECHNICAL FIELD

The present invention is in the field of mechanically testing the adhesion force/bond strength of thin film interfaces of optoelectronic components on wafer level.

### BACKGROUND

Due to process variations, the adhesion force/bond strength between heterogeneous thin films of optoelectronic components on for example wafer level, e.g. metal on metal oxide, metal on semiconductor interfaces, or metal on polymer interfaces, can vary. This can lead to unwanted detachment of the metal during aging of the material, during a wire-bond process, or during further processing of the optoelectronic components.

Also in the design of temporary support structures for optoelectronic components on a wafer comprising a thin film interface, the adhesive force/bond strength of the interface plays a decisive role to be able to safely detach the optoelectronic component from the support structure of the wafer (e.g. by means of a stamping process).

Since interfaces can behave differently despite nominally identical processes, a test at wafer level is particularly interesting. However, there are no mechanical test methods known which can be used to determine the adhesion force/bond strength between thin films which are deeply embedded in a ridged multilayer stack.

Various other conventional mechanical test methods, not being suitable for aforementioned use, are for example:
The “scotch tape test” where the adhesion of a thin film is measured by whether film residues remain on the scotch tape when it is pulled off the thin film. This however represents only a purely qualitative test;
The “4-point bending test” by which the mechanical properties of a layer stack can be determined by the fracture propagation through an interface of the layer stack. For this purpose, a predetermined breaking point is introduced into the upper layer of a layer stack and the layer stack is then bent. Starting from the predetermined breaking point, the interface fails and, if the mechanical properties of the lower layer are known, the properties of the upper layer can be inferred;
By means of the induced thermal expansion and by the damage caused due to a laser ablation of a sacrificial layer in a thin film layer stack, conclusions can be drawn about the interface strength;
In the case of electrically conductive thin film layers, the mechanical properties of a layer can be derived due to the heat loss when a current and cyclically induced stress is applied to the layer; and
Due to nano indentation by means of atomic force microscopy (AFM) the mechanical properties of a thin film layer can be determined due to the deformation of the material of the layer around a needle indentation.

However such a method is limited to surfaces.

The shown methods for mechanical tests on thin films require either electrically conductive layers or the layer to be tested must be located directly on the surface. In addition to this, the above shown methods are difficult to implement in high-volume production and are only conditionally suitable for embedded interfaces.

### SUMMARY

Embodiments provide a method for performing a mechanical adhesion test for thin film interfaces which is easy to be implemented in a high-volume production and is addition suitable for embedded interfaces.

A method for performing a mechanical adhesion test for thin film interfaces according to the invention comprises the step of providing a substrate with a plurality of electronic components and at least one test component arranged on a support element on the substrate. The at least one test component is thereby arranged adjacent to at least one of the plurality of the electronic components and the support element comprises a plurality of first support pillars each connected to the substrate and an interface layer. The interface layer is arranged between the electronic components and the at least one test component, respectively, and the first support pillars, and the interface layer is forming a top surface of the first support pillars. The at least one test component is arranged on the top surface of an associated first support pillar, such that the at least one test component protrudes a projection of the top surface at least in a first direction. In addition, the method is further comprising the steps of applying a force to the at least one test component in a first area outside the projection of the top surface, and determining the force applied to the at least test component and/or the deflection of the at least one test component over time.

In this regard, the electronic components may comprise optoelectronic components like LEDs but also circuitry components based on silicon or other semiconductor material. These components may provide functionality, may comprise logic functionality, like inverter logic gates and the like, as well as analogue functionality like amplifiers, comparators, limiters, controlled sources, registers, filters and the like. The components may also comprise processing unit and processors as well as any combination thereof. For the purpose of simplicity, the electronic component is further referred to as optoelectronic component.

By means of the test method according to the invention, the interface strength of embedded interfaces can be qualitatively and quantitatively investigated via a special test component in combination with an associated support element that can be implemented at wafer level. The test component consists of a bar of material that can be machined out of a stack of layers resting on one or more support pillars. To test the interface strength, a force is applied to one end of the test component and the force versus time curve and/or the deflection over time curve is recorded during this time to determine the interface strength from the breaking force. However, it can also be of use to draw the force versus deflection curve to determine the interface strength from the breaking force. The test component can for example be formed as a horizontal bar, which rests asymmetrically on the one or more support pillars in order to adjust the sensitivity of the test component via a leverage effect.

In some embodiments, the test component can be formed as a horizontal bar, which rests asymmetrically or symmetrically on one support pillar. In particular at least a portion of the horizontal bar protrudes a projection of the support pillar. The first area, in which the force is applied to the test component, thereby lies outside the projection of the support pillar. Due to such an arrangement of the test component on the one support pillar, both a compressive and tensile force results in the interface layer between the test component and the one support pillar, as the test component starts to tilt due to the applied force.

In some embodiments, the interface to be tested is located between the associated test component and the outermost support pillar on the substrate. Thus the at least one test component and the associated first support pillar are arranged in an edge region of the substrate.

In some embodiments, the step of applying a force to the at least one test component is performed by use of an AFM (atomic force microscope) tip or an indentor. Hence, an AFM can be used, for example, to manipulate the test component. The use of an AFM makes the test for example suitable for mass production. In some embodiments, a piezo transducer with cantilever/tip is suitable as a micromanipulator for applying the force to the test component in order to be able to infer the applied force via the spring force and deflection of the cantilever.

In some embodiments, the method further comprising a step of determining the adhesion force between the at least one test component and the associated first support pillar in response to the determined force and/or deflection of the at least one test component. Hence, the results of the step of determining the force applied to the test component and/or the deflection of the test component over time are used to determine the adhesion force of the interface layer between the test component and the respective support pillar.

In some embodiments, the support element comprises at least one second support pillar arranged between the at least one test component and the substrate. The at least one second support pillar can be arranged adjacent to the first support pillar being associated to the at least one test component. Further to this, the at least one test component protrudes in some embodiments a projection of the at least one second support pillar at least in the first direction. The at least one test component is thus arranged on two adjacent support pillars, a first support pillar and a second support pillar, such that, when viewing in a direction perpendicular to the substrate, the test component overlaps the top surface of the first support pillar and a top surface of the second support pillar at least in the first direction.

In some embodiments, the first area is selected to be arranged, along the first direction, after the projections of the at least one second support pillar and the top surface of the first support pillar. The first area can thus be selected outside the projection of the at least one second support pillar and the top surface, such that the projection of the at least one second support pillar is, along the first direction, arranged between the first area and the projection of the top surface. In other words, the first area can be selected substantially along a virtual line, for example a line along the first direction, defined through the projections of the first and the at least one second support pillar outside a portion of said virtual line between said projections of the first and the at least one second support pillar. By placing a second support pillar between the test component and the substrate, the compression movement explained for only one support pillar between the test component and the substrate can be redirected into a tensile movement. Thus, the interface can be tested with different loading modes.

The test component can be formed as a horizontal bar, which lies asymmetrically on a first and a second support pillar. This can help to limit the resulting force in the interface to a pure tensile force, as the second support pillar can be arranged under the test component to redirect the force applied in the first area, as in a rocker. By this, a reproducibility of the mechanical adhesion test can be improved. The spacing of the support pillars can thereby be varied and optimized to improve reproducibility and sensitivity of the method.

In some embodiments, the at least one test component comprises a layer structure similar to the plurality of optoelectronic components. The test component can for example comprise a complete epi-stack similar to the plurality of optoelectronic components or can be any other finished component whose adhesive force to a support structure is to be determined.

In some embodiments, the projection of the top surface of the first support pillars and/or the projection of the at least one second support pillar comprises one of the following shapes:
Rectangle;
Square;
Oval;
Circle;
Triangle; and
Trapezoid.

The shape of the support pillars can in particular be varied and optimized to improve reproducibility and sensitivity of the method.

In some embodiments, the method further comprises a step of tearing the at least one test component from the associated first support pillar. The force applied to the first area can for example be increased over time such that the test component starts to tilt until finally the interface between the test component and the associated first support pillar breaks.

In some embodiments, the interface layer comprises a first thin film and a second thin film arranged on top of each other. When the at least one test component is teared from the associated first support pillar, and thus the interface between the test component and the associated first support pillar breaks the second thin film layer can for example remain on the at least one test component.

The interface layer can for example be a structured layer such that regions of the structured interface layer are at least of the same size as the projections of the first support pillars when viewing in a direction perpendicular to the substrate. The regions of the structured interface layer arranged between the optoelectronic components and the at least one test component, respectively, and the first support pillars can for example comprise the same material composition and the same size.

In some embodiments, the interface layer can be a structured layer comprising a first thin film and a second thin film. The second thin film can thereby comprise regions that are at least of the same size as the projections of the first support pillars when viewing in a direction perpendicular to the substrate. In some embodiments, the regions of the second thin film are of the same size as regions of the first thin film, however, the regions of the second thin film can protrude regions of the first thin film at least in one direction.

A concrete application example, of a mechanical adhesion test according to the invention would be an adhesion test of LED chips on support pillars made of e.g. BCB on a substrate (wafer). The adhesion force is thereby of importance if the chips are to be transferred from the wafer by means of a stamping process (e.g. display assembly). Here it is crucial that the adhesion between BCB and LED chip is not stronger than the adhesion between a stamp and the LED chip and that the chip cannot be detached.

A wafer structure according to the invention comprises a substrate having a plurality of first support elements and at least one second support element. The wafer structure further comprises a plurality of optoelectronic components arranged on a respective one of the plurality of first support elements and at least one test component arranged on a respective one of the at least one second support element. Each support element of the plurality of first support elements comprises a first support pillar and an interface layer, wherein said interface layer is arranged between the respective support element and the optoelectronic component. The at least one second support element comprises a first support pillar and an interface layer on the first support pillar as well as a second support pillar. The at least one test component is arranged on the interface layer and the second support pillar such that the test component protrudes a projection of the second support pillar and a projection of the associated first support pillar in at least a first direction.

The test component can be formed as a horizontal bar, which lies in particular asymmetrically on a first and a second support pillar, such that, when viewing in a direction perpendicular to the substrate, the test component overlaps a top surface of the first support pillar and a top surface of the second support pillar at least in the first direction. The first and the second support pillar can thereby be arranged adjacent to each other on the substrate.

In some embodiments, the at least one test component is arranged adjacent to at least one of the plurality of the optoelectronic components. In some embodiments, the at least one test component and the associated first support pillar and second support pillar are arranged in an edge region of the substrate.

In some embodiments, the at least one test component comprises a layer structure similar to the plurality of optoelectronic components. The test component can for example comprise an epi-stack similar to the plurality of optoelectronic components or can be any other finished component whose adhesive force to a support structure is to be determined.

In some embodiments, the projection of the first support pillars and/or the projection of the at least one second support pillar comprises one of the following shapes:
Rectangle;
Square;
Oval;
Circle;
Triangle; and
Trapezoid.

In some embodiments, an atomic force microscope tip is used to perform a mechanical adhesion test for a thin film interface of a test component of a wafer structure according to any one of the aforementioned embodiments. The atomic force microscope tip is thereby configured to apply a force to the test component in a first area, wherein the first area is selected to be arranged, along the first direction, after the projections of the at least one second support pillar and the first support pillar associated to the test component.

### BRIEF DESCRIPTION OF THE DRAWINGS

In the following, embodiments of the invention will be explained in more detail with reference to the accompanying drawings.

FIG. 1A to FIG. 1C show steps of a method for performing a mechanical adhesion test for thin film interfaces according to some aspects of the invention;

FIG. 2A to FIG. 2C show each a top view of a test component according to some aspects of the invention;

FIGS. 3A and 3B show steps of another embodiment of a method for performing a mechanical adhesion test for thin film interfaces according to some aspects of the invention as well as a wafer structure according to some aspects of the invention;

FIG. 4 shows a top view of a test component of a wafer structure according to some aspects of the invention; and

FIGS. 5A and 5B show steps of another embodiments of a method for performing a mechanical adhesion test for thin film interfaces according to some aspects of the invention as well as wafer structures according to some aspects of the invention.

### DETAILED DESCRIPTION OF ILLUSTRATIVE EMBODIMENTS

The present disclosure will now be described more fully hereinafter with reference to the accompanying drawings, in which exemplary embodiments of the disclosure are shown. The disclosure may, however, be embodied in many different forms and should not be construed as limited to the embodiments set forth herein; rather, these embodiments are provided for thoroughness and completeness. Like reference characters refer to like elements throughout the description. The drawings are not necessarily to scale and certain features may be exaggerated in order to better illustrate and explain the exemplary embodiments of the present disclosure.

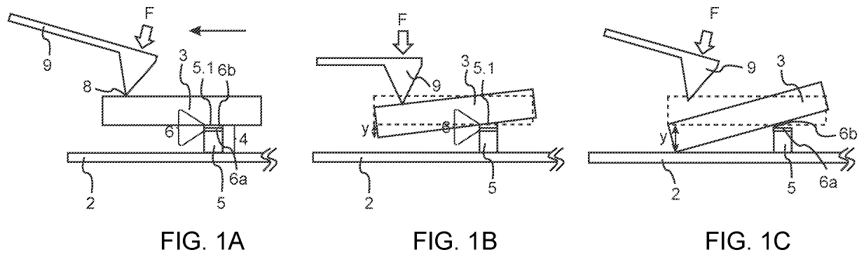

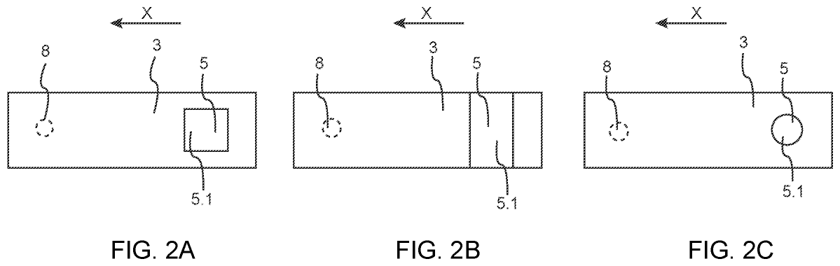

FIGS. 1A to 1C show steps of a method for performing a mechanical adhesion test for thin film interfaces according to some aspects of the invention. It is provided a substrate 2 with a plurality of optoelectronic components (not shown) and at least one test component 3 (only one is shown) arranged on a support element 4 on the substrate 2. The support element 4 comprises a first support pillar 5, which is connected to the substrate 2 and an interface layer 6. The interface layer 6 is arranged between the test component 3 and the first support pillar 5 and is forming a top surface 5.1 of the first support pillar 5. Further to this, the test component 3 is arranged on the top surface 5.1 of the associated first support pillar 5, such that the test component 3 protrudes a projection of the top surface 5.1 at least in a first direction X. In the example shown, the test component 3 is arranged asymmetrically on the top surface 5.1 and protrudes the top surface 5.1 into the first direction X as well in the direction opposite to the direction X, however the test component 3 protrudes the top surface 5.1 further into the first direction X as into the direction opposite to the direction X (see also FIGS. 2A to 2C).

Even if it is not shown, the test component 3 is in particular arranged adjacent to at least one of the plurality of the optoelectronic components and even more particular, the test component 3 and the associated first support pillar 5 are arranged in an edge region of the substrate 2.

Between each of the plurality of the optoelectronic components and the substrate 2, there is also arranged a first support pillar 5 and an interface layer 6 as explained for the test component 3. The interface layer 6 between the substrate 2 and the test component 3, and the interface layers between the substrate 2 and the optoelectronic components are thereby in particular formed of the same material and of the same size.

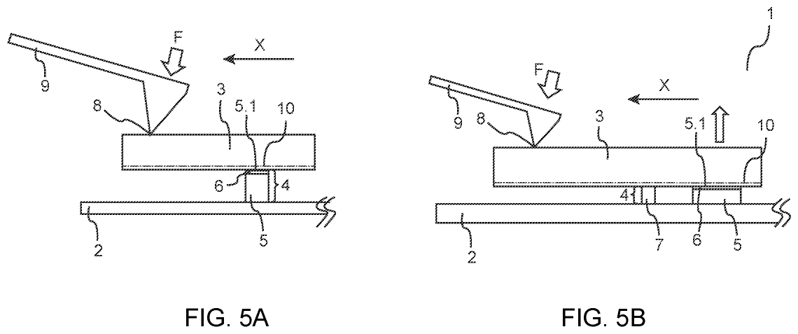

As it can be seen from the figures, the interface layer 6 comprises a first thin film 6a and a second thin film 6b arranged on top of each other forming a thin film interface to be tested. However as shown in the following FIGS. 5A and 5B, the interface layer 6 can comprise only one layer forming the top surface 5.1 of the associated first support pillar 5.

The method shown in FIGS. 1A to 1C further comprises a step of applying a force F to the test component 3 in a first area 8. The first area 8 is thereby located on the test component in an area outside the projection of the top surface 5.1. Due to the force F, the test component 3 starts to tilt (see FIG. 1B) until finally the interface 6 between the test component 3 and the associated first support pillar 5 breaks (see FIG. 1C). At the same time, the force F, applied to the test component 3 and the deflection y of the test component 3 is determined over the time t, to determine the interface 6 strength from the breaking force.

As shown in FIG. 1C, the interface 6 between the test component 3 and the associated first support pillar 5 breaks in such a way, that the first thin film 6a remains on the first support pillar and the second thin film 6b remains on the test component. Thus the weakest connection in the layer stack can for example occur between the first thin film 6a and a second thin film 6b. This is however only an exemplary example, and the failure of the interface layer can take place in any other possible way as well.

FIGS. 2A to 2C show embodiments of a top view of a test component 3 with first support pillars 5 connected to the test component 3 with different cross sectional shapes. Thus the top surfaces 5.1 of the support pillars 5 comprise a different shape. In a first example, the top surface 5.1 comprises the shape of a square (see FIG. 2A), in a second example, the top surface 5.1 comprises the shape of a rectangle (see FIG. 2B), and in a third example, top surface 5.1 comprises the shape of a circle (see FIG. 2C). The shape of the top surface 5.1/cross section of the support pillars 5 can in particular be varied and optimized to improve reproducibility and sensitivity of the method.

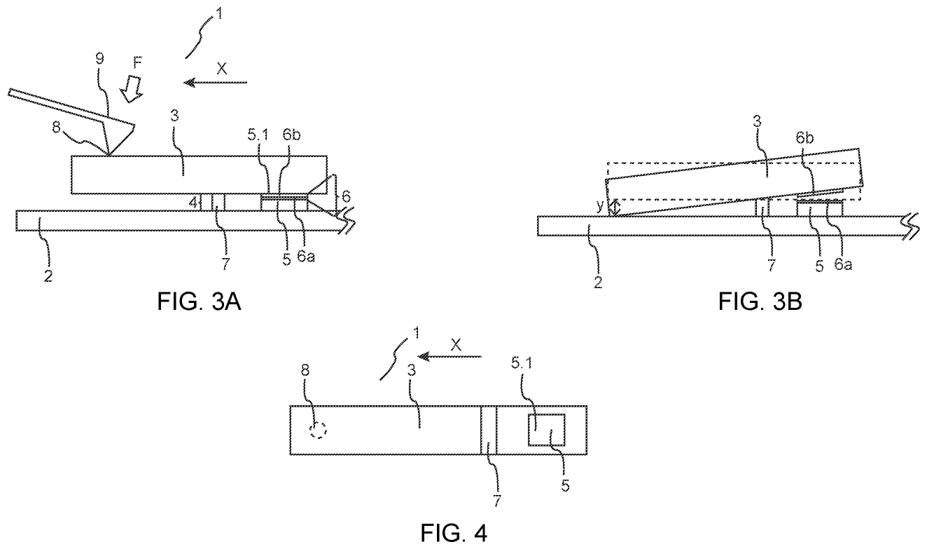

FIGS. 3A and 3B show steps of another embodiment of a method for performing a mechanical adhesion test for thin film interfaces according to some aspects of the invention as well as FIG. 3A shows a wafer structure according to some aspects of the invention. In addition to the embodiment shown in FIG. 1A a second support pillar 7 is arranged between the test component 3 and the substrate 2 adjacent to the first support pillar 5. The test component 3 not only protrudes the projection of the first support pillar 5 at least in the first direction X but in addition protrudes the projection of the second support pillar 7 at least in the first direction X (see also FIG. 4).

The method shown in FIGS. 3A to 3C comprises as also described for figures iA to 1C a step of applying a force F to the test component 3 in a first area 8. The first area 8 is thereby located on the test component in an area outside the projection of the top surface 5.1 and the second support pillar 7. In particular, the first area 8 is selected to be arranged, along the first direction X, after the projections of the second support pillar 7 and the top surface 5.1 (see therefore also FIG. 4).

Due to an arrangement of the test component 3 on only one first support pillar 5, as shown in FIGS. 1A to 1C both a compressive and tensile force results in the interface layer 6 between the test component 3 and the first support pillar 5, as the test component starts to tilt due to the applied force F. Due to an arrangement of the test component 3 on a first support pillar 5 and a second support pillar 7, as shown in FIGS. 3a and 3B, the aforementioned compression force between the test component 3 and the first support pillar 5 can be redirected into a tensile force. The test component 3 is thus arranged on the first and a second support pillar 5, 7 as in a rocker. This can help to limit the resulting force in the interface 6 to a pure tensile force, as the compression force acts to the second support pillar 7 and not the interface 6.

The above examples can be distributed across a wafer, such that a plurality of test structures are arranged on the wafer. This will allow determining a respective force profile across the wafer when the individual devices are to be transferred. Further, one may consider using some optoelectronic devices themselves as test structures. This will significantly simplify the processing steps of the wafer, as not all masks have to be re-designed. Rather, only some few masks needs to be changed in order, —for example—, to form the second support structure. Furthermore, a method, in which one or more optoelectronic devices are used as test structures, may offer an additional flexibility in selecting test structures across the wafer.

FIGS. 5A and 5B each show a step of another embodiment of a method for performing a mechanical adhesion test for thin film interfaces according to some aspects of the invention as well as a wafer structure according to some aspects of the invention. Compared to the wafer structure shown in FIGS. 1A and 3A, the interface layer 6 only comprises one layer forming the top surface 5.1 of the associated first support pillar 5. The interface layer 6 can therefore be part of the first support pillar 5 and comprise of the same material as the first support pillar 5 or at least of an upper portion of the first support pillar 5.

When applying the force F to the test component 3 in the first area 8 the interface 6 between the test component 3 and the associated first support pillar 5 breaks along the top surface 5.1. The interface between the test component 3 and the associated first support pillar 5 breaks in such a way, that the interface layer 6 remains on the first support pillar. Thus, the weakest connection in the layer stack of the first support pillar and the test component 3 can for example occur between the interface layer 6 and the test component 3. This is however only an exemplary example, and the failure of the interface layer can take place in any other possible way as well.

As also shown in FIGS. 5A and 5B the test component 3 can comprise a further layer 10, in particular further interface layer, indicated by the dotted lines as being an optional layer. The further layer can comprises a thin film being arranged on a bottom surface of the test component facing the support element 5. The further layer 10 covers the whole bottom surface of the test component 3 but can however cover only regions of the bottom surface as well. The further layer 10 can be part of the test component 3 and can comprise of the same material as the test component 3 or at least of a lower portion of the test component 3.

When applying the force F to the test component 3 in the first area 8 the interface between the test component 3 and the associated first support pillar 5 breaks along the interface between the interface layer 6 and the further layer 10. The interface between the test component 3 and the associated first support pillar 5 breaks in such a way, that the interface layer 6 remains on the first support pillar and the further layer 10 remains on the test component 3. Thus, the weakest connection in the layer stack of the first support pillar and the test component 3 can for example occur between the interface layer 6 and the further layer 10. This is however only an exemplary example, and the failure of the interface layer can take place in any other possible way as well.

1-15. (canceled)

16. A method for performing a mechanical adhesion test for thin film interfaces, the method comprising:
providing a substrate with a plurality of optoelectronic components and at least one test component arranged on a support element on the substrate,
wherein the at least one test component is adjacent to at least one of the plurality of the optoelectronic components,
wherein the support element comprises a plurality of first support pillars each connected to the substrate and an interface layer arranged between the optoelectronic components and the at least one test component, respectively, and the first support pillars, the interface layer forming a top surface of the first support pillars, and
wherein the at least one test component is arranged on the top surface of an associated first support pillar such that the at least one test component protrudes a projection of the top surface at least in a first direction;
applying a force to the at least one test component in a first area outside the projection of the top surface; and
determining the force applied to the at least test component and/or a deflection of the at least one test component over time.

17. The method according to claim 16, wherein applying the force to the at least one test component comprises using a force transducer.

18. The method according to claim 16, further comprising determining an adhesion force between the at least one test component and the associated first support pillar in response to the determined force and/or the determined deflection.

19. The method according to claim 16, wherein the support element comprises at least one second support pillar in addition to the first support pillar arranged between the at least one test component and the substrate.

20. The method according to claim 19, wherein the at least one second support pillar is arranged adjacent to the first support pillar associated with the at least one test component, and wherein the at least one test component protrudes a projection of the at least one second support pillar at least in the first direction.

21. The method according to claim 20, wherein the first area is selected to be arranged, along the first direction, after the projections of the at least one second support pillar and the top surface.

22. The method according to claim 16, wherein the at least one test component comprises a layer structure similar to the plurality of optoelectronic components.

23. The method according to claim 20, wherein the projection of the top surface and/or the projection of the at least one second support pillar comprises one of the following shapes: rectangle, square, oval, circle, triangle, or trapezoid.

24. The method according to claim 16, further comprising tearing the at least one test component from the associated first support pillar.

25. The method according to claim 24, wherein the interface layer comprises a first thin film and a second thin film arranged on top of each other, and wherein the second thin film layer remains on the at least one test component when the at least one test component is teared from the associated first support pillar.

26. A wafer structure comprising:
a substrate having a plurality of first support elements and at least one second support element;
a plurality of optoelectronic components arranged on a respective one of the plurality of first support elements; and
at least one test component arranged on a respective one of the at least one second support element,
wherein each support element of the plurality of first support elements comprises a first support pillar and an interface layer, the interface layer being arranged between the respective support element and the optoelectronic component,
wherein the at least one second support element comprises a first support pillar and an interface layer on the first support pillar and a second support pillar,
wherein the at least one test component is arranged on the interface layer and the second support pillar such that it protrudes a projection of the at least one second support pillar and a projection of the associated first support pillar in at least a first direction.

27. The wafer structure according to claim 26, wherein the at least one test component is adjacent to at least one of the plurality of the optoelectronic components.

28. The wafer structure according to claim 26, wherein the at least one test component comprises a layer structure similar to the plurality of optoelectronic components.

29. The wafer structure according to claim 26, wherein the projection of the first support pillars and/or the projection of the at least one second support pillar comprises one of the following shapes: rectangle, square, oval, circle, triangle, or trapezoid.

30. A method for using of an atomic force microscope tip to perform a mechanical adhesion test for a thin film interface of the test component of the wafer structure according to claim 26,
wherein the atomic force microscope tip is configured to apply a force to the test component in a first area, which is selected to be arranged, along the first direction, after the projections of the at least one second support pillar and the associated first support pillar.
